(19) United States
(12) Patent Application Publication
(10) Pub. No.: US 2026/0283393 A1
(43) Pub. Date: Sep. 24, 2026

(54) BEVERAGE MAKING ASSEMBLY

(71) Applicant: HCL Technologies Limited, New Delhi (IN)

(72) Inventors: Akash Mohan Salunkhe, Satara (IN); Yuvaraj D Patil, Kolhapur (IN)

(21) Appl. No.: 19/330,923

(22) Filed: Sep. 17, 2025

(30) Foreign Application Priority Data
Mar. 20, 2025 (IN) 202511025106

(51) Int. Cl. A47J 31/40; A47J 31/41; A47J 31/46

(52) U.S. Cl. CPC A47J 31/407; A47J 31/41; A47J 31/461; A47J 31/468

(57) ABSTRACT

A beverage making assembly is disclosed. The assembly includes a flavor storage configured to store a flavoring agent. The flavor storage includes an enclosure, an opening coupled to the enclosure, and a valve disposed within the opening. The assembly includes at least one container fluidically coupled to the valve. The assembly includes a plunger disposed within the at least one container and disposed in a cross-section of an outlet pipe of a water storage. The assembly further includes an actuator pivoted on the outlet pipe and operatively coupled to the plunger. The actuator actuated to move the plunger through the at least one container and the cross-section for dispersing the flavoring agent to water flowing through the cross-section for making a beverage.

### DESCRIPTION

### Technical Field

This disclosure relates generally to the field of beverages, more particularly to an assembly of making beverage.

### Background

Beverages are flavor liquids intended for human consumption, therefore capable of satisfying thirst. The beverages may be carbonated and non-carbonated. Further, the non-carbonated beverages may be made in household settings or may be accessed through a packaged source. However, making non-carbonated beverages in household settings may be inconsistent in taste and the packaged sources are prepared with emulsifiers, excessive sugar, and artificial colors without regulatory control in quantities.

Further, the plain water utilized in the domestic setting offers a monotonous taste, which discourages regular consumption. Therefore, plain water may be substituted with flavored beverages. However, the manual measuring and mixing of flavoring concentrates is a time-consuming process requiring a defined skill set. Further, flavoring an entire water reservoir forces users to stick with one flavor, limiting variety and options. Additionally, numerous flavoring solutions necessitate electrical components or complex installations, and opting for such solutions may be monetarily unsustainable and have high maintenance, particularly in regions with limited resources.

Accordingly, there is a requirement for a solution to make a beverage by controllably allowing the flow of flavoring agents in the water.

### SUMMARY

In an embodiment, a beverage making assembly is disclosed. The beverage making assembly may include a flavor storage configured to store a flavoring agent. The flavor storage may include an enclosure, an opening coupled to the enclosure, and a valve disposed within the opening. The beverage making assembly may include at least one receptacle fluidically coupled to the valve. Each receptacle may be configured to receive the flavoring agent from the flavor storage via the valve. The beverage making assembly may further include a plunger disposed within the at least one receptacle and disposed in a cross-section of an outlet pipe of a water storage. Further, the plunger may include one or more notches. Each notch may allow a flow of the flavoring agent across at least one receptacle, and from at least one receptacle to the cross-section of the outlet pipe. Further, the beverage making assembly may include an actuator pivoted on the outlet pipe and operatively coupled to the plunger. The actuator may be actuated to move the plunger through the at least one receptacle and the cross-section for dispersing the flavoring agent to the cross-section. Further, the flavoring agent is configured to be mixed with a water flowing through the cross-section for making a beverage.

In another embodiment, a water storage is disclosed. The water storage may include an outlet pipe and a beverage making assembly coupled to the outlet pipe. The beverage making assembly may include a flavor storage configured to store a flavoring agent. The flavor storage may include an enclosure, an opening coupled to the enclosure, and a valve disposed within the opening. The beverage making assembly may include at least one receptacle fluidically coupled to the valve. Each receptacle may be configured to receive the flavoring agent from the flavor storage via the valve. The beverage making assembly may further include a plunger disposed within the at least one receptacle and disposed in a cross-section of an outlet pipe of a water storage. Further, the plunger may include one or more notches. Each notch may allow a flow of the flavoring agent across at least one receptacle, and from at least one receptacle to the cross-section of the outlet pipe. Further, the beverage making assembly may include an actuator pivoted on the outlet pipe and operatively coupled to the plunger. The actuator may be actuated to move the plunger through the at least one receptacle and the cross-section for dispersing the flavoring agent to the cross-section. Further, the flavoring agent is configured to be mixed with a water flowing through the cross-section for making a beverage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a perspective view of a water storage equipped with a beverage making assembly, in accordance with an embodiment of the present disclosure.

FIG. 2 illustrates a sectional view of the beverage making assembly, in accordance with an embodiment of the present disclosure.

FIG. 3 illustrates a first-sectional view of the beverage making assembly in an actuated state, in accordance with an embodiment of the present disclosure.

FIG. 4 illustrates a second-sectional view of the beverage making assembly in the actuated state, in accordance with an embodiment of the present disclosure.

FIG. 5 illustrates a sectional view of the beverage making assembly with a dual-container configuration, in accordance with an embodiment of the present disclosure.

FIG. 6 illustrates a sectional view of the beverage making assembly of FIG. 5, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises… a” does not, without more constraints, preclude the existence of other elements or additional elements in the system or apparatus.

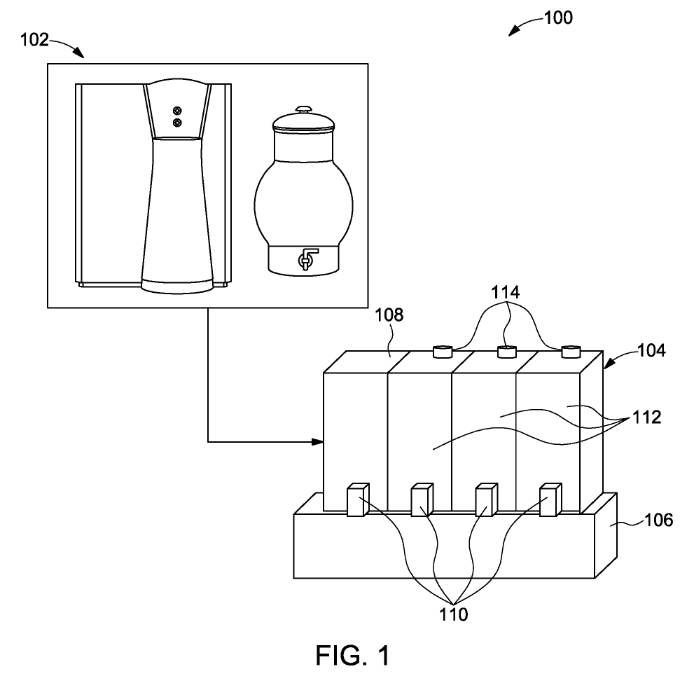

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-6. It is to be noted that the assembly may be employed in any water storage including but not limited to a water filter, a water pot, and the like.

Referring to FIG. 1, a perspective view 100 of a water storage 102 equipped with a beverage making assembly 104 is illustrated, in accordance with an embodiment of the present disclosure. In an embodiment, the water storage 102 may be configured to store a predefined amount of water. By way of example, the water storage 102 may include but not limited to a water filter, a water pot, and the like. The water storage 102 may include a base 106 and a receptacle 108 disposed on the base 106. The receptacle 108 may be configured to store the water in the predefined amount. The water storage 102 may include a plurality of connectors (not shown in FIG.) and a plurality of hoses (not shown in FIG.) adjoined to the plurality of connectors. Further, one hose from the plurality of hoses may be configured to connect the water storage 102 to the receptacle 108, thereby allowing water to be received by the receptacle 108. It is to be noted, the water storage 102 may be configured to receive water from a water supply (not shown) of a household.

The receptacle 108 of the water storage 102 may include a valve (not shown) and an outlet pipe (not shown) coupled to the valve. Further, the outlet pipe may define a cross-section (not shown in FIG. 1) configured to allow flow of water within the outlet pipe from the receptacle 108 via the valve. The outlet pipe may include a first intake (not shown) coupled to the receptacle 108, a second intake (not shown) disposed inline to the first intake, and an outlet (not shown). The outlet may be configured to dispense the water for consumption. By way of example, the outlet may be a tap (not shown in FIG) or may be coupled to an inner section of the tap. Accordingly, the water from the receptacle 108 may flow through the cross section of the outlet pipe towards the outlet for consumption.

In an embodiment, the receptacle 108 may include a knob 110 coupled to the valve, and may be configured to regulate a flow of water towards the cross section of the outlet pipe. Further, the receptacle 108 may be coupled to a plurality of flavor storages 112 disposed on the base 106. Each flavor storage 112 may define an enclosure configured to accommodate a flavoring agent. By way of example, the flavor liquid may include but not limited to a concentrated fruit-based syrup, a coffee concentrate, and the like. Further, each flavor storage 112 may include the valve configured to allow dispersion of the flavoring agent within the water flowing in the cross-section of the outlet pipe. Further, each flavor storage 112 may include an inlet port 114 configured to change or refill the flavoring agent. Further, each flavor storage 112 may include an indicator (not shown) configured to indicate an amount of flavoring agent available. By way of example, the indicator may be a transparent shield, or a plurality of level markings on a transparent section formed on an outer surface of the flavor storage 112. As explained earlier, the water flowing in the cross-section of the outlet pipe may be unflavored and the flavor liquid may be required to be dispersed within the cross-section.

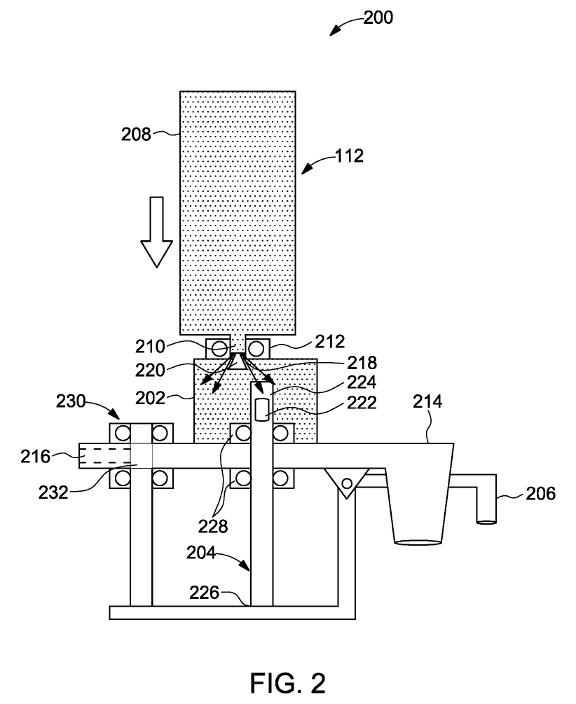

Therefore, the beverage making assembly 104 may be coupled to the outlet pipe of the water storage 102. Further, the beverage making assembly 104 may be coupled to the receptacle 108 and disposed on the base 106. The beverage making assembly 104 may include the plurality of flavor storages 112. The beverage making assembly 104 may be configured to disperse a predefined amount of the flavoring agent in the water flowing through the cross-section via the valve. Consequently, the beverage making assembly 104 may be configured to make a beverage by mixing the flavoring agent within the water flowing in the cross-section. Additionally, the flow of the flavoring agent from the flavor storage 112 may be regulated by the knob 110. The assembly and operation of the beverage making assembly with the outlet pipe of the water storage is explained in greater detail in conjunction with FIGS. 2-6.

In an embodiment, referring to FIG. 2 , which illustrates a sectional view 200 of the beverage making assembly 104, in accordance with an embodiment of the present disclosure. In an embodiment, the beverage making assembly 104 may include the flavor storage 112, at least one container 202 coupled to the flavor storage 112, a plunger 204 disposed within the container 202, and an actuator 206 operatively coupled to the plunger 204.

The flavor storage 112 may be configured to store the flavoring agent. Further, the flavor storage 112 may include an enclosure 208, an opening 210 coupled to the enclosure 208, and a valve 212 disposed within the opening 210. The enclosure 208 may define a storage capacity to store the predefined amount of the flavoring agent. Further, the enclosure 208 may be inversely attached to the valve 212. Due to such attachment, a force of gravity may act on the flavoring agent. By virtue of the force of gravity, the flavoring agent may be directed in a downward direction i.e., towards the at least one container 202.

The opening 210 may be coupled to the valve 212. For example, the opening 210 may be a threaded opening and the valve 212 may include a threaded inlet configured to accommodate the threaded opening. The valve 212 may be configured to regulate the flow of the flavoring agent towards the at least one container 202. By way of example, the valve 212 may be operated by the knob 110 manually or electronically.

It is to be noted that, the flavoring agent may flow through the valve 212 in a predefined amount. The predefined amount may be regulated by the valve 212. For example, the valve 212 may include the threaded inlet and an orifice (not shown in FIG. 2) formed at the threaded inlet and a rotary opening lid (not shown in FIG. 2) adjoined to the threaded inlet. Further, the orifice may be configured to allow flow of the flavoring agent into the at least one container 202 upon actuation of the valve 212 via the knob 110. Moreover, the rotary opening lid may be rotated to adjust the position of the threaded inlet relative to the at least one container 202. Accordingly, the flavoring agent may flow into the at least one container 202 based on a quantity of the flavoring agent in the at least one container 202. It is to be noted, the flavoring agent may continuously and steadily flow into the at least one container when the quantity of the at least one container 202 recedes a predefined threshold. The predefined threshold may include a full-capacity of the flavoring agent in the at least one container 202. As explained earlier, the quantity of flavoring agent may be depicted by the plurality of markings on the enclosure 208. The assembly of the at least one container 202 is explained in greater detail, hereinafter.

The at least one container 202 may be fluidically coupled to the valve 212 and disposed on an outlet pipe 214 of the water storage 102. The outlet pipe 214 may define a cross-section 216 configured to allow the flow of water therethrough. Each container 202 may be configured to receive the flavoring agent from the flavor storage 112 via the valve 212. The flavoring agent may be configured to be mixed with the water flowing in the cross-section 216.

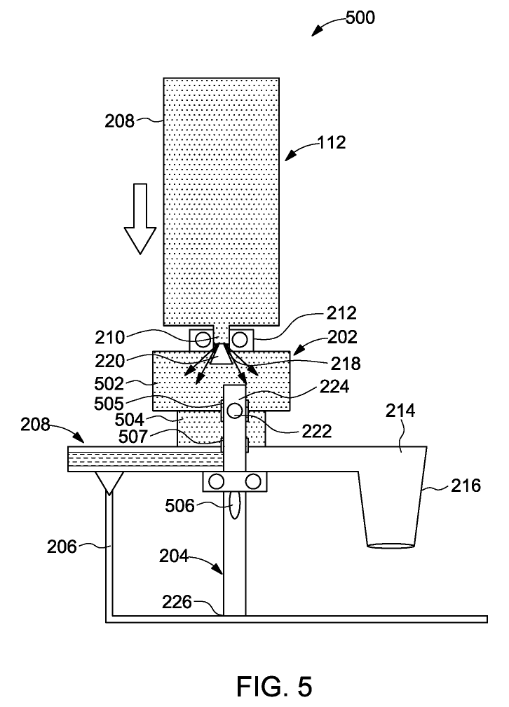

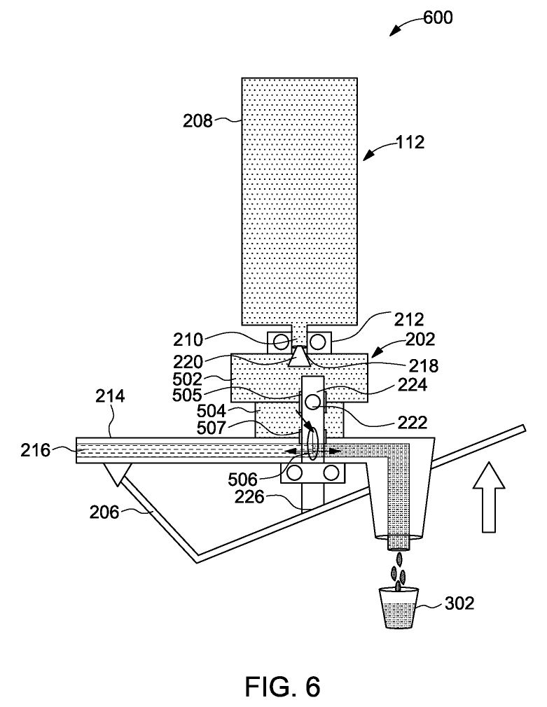

In an embodiment, the at least one container 202 may be any one of a single-container configuration or a dual-container configuration. As apparent from FIG. 2, the at least one container 202 may be in the single-container configuration. Further, the dual-container configuration is explained in greater details in conjunction with FIGS. 5-6.

As apparent from FIG. 2, in the single-container configuration, the at least one container 202 may include a first cavity 218 coupled to the valve 212 and a second cavity (not shown) formed with the outlet pipe 214. The first cavity 218 may include a needle 220 configured to pierce the opening 210 of the flavor storage 112 such that the flavoring agent may flow towards the at least one container 202. Further, the second cavity may be configured to allow the dispersion of the flavoring agent within the cross-section 216. The dispersion of the flavoring agent within the cross-section 216 is explained in greater detail hereinafter.

The plunger 204 may be disposed within the at least one container 202 and disposed in the cross-section 216 of the outlet pipe 214 of the water storage 102. Moreover, the plunger 204 may be movably engaged to the at least one container 202. Therefore, the plunger 204 may be configured to accommodate and disperse the flavoring agent to the cross-section 216. Further, the plunger 204 may include one or more notches 222, and each notch 222 may allow the flow of the flavoring agent across at least one container 202, and from at least one container 202 to the cross-section 216 of the outlet pipe 214. The assembly of the plunger 204 is explained in greater details, hereinafter.

The plunger 204 may include a top portion 224 disposed within the at least one container 202 and a bottom portion 226 disposed opposite to the top portion 224, and coupled to the actuator 206. The top portion 224 may include a top notch from the one or more notches 222. The top notch 222 may define a cavity configured to receive the flavoring agent from the at least one container 202 and dispense the flavoring agent to the cross-section 216 of the outlet pipe 214 in response to a vertical downward movement of the plunger 204. The plunger 204 may move through the at least one container 202 and the cross-section 216 in response to the actuation of the actuator 206. Such movement of the plunger may be susceptible to leakage of the flavoring agent from the cross-section 216. Therefore, a pair of O-rings 228 may be positioned with the outlet pipe 214. Therefore, the pair of O-rings 228 may be configured to seal the cross-section 216 with the plunger 204, thereby prevent leakage of the flavoring agent, and allow the movement of the plunger 204 through the at least one container 202. Further, the assembly of the actuator 206 relative to the plunger 204 is explained in greater details, hereinafter.

The actuator 206 may be pivoted on the outlet pipe 214 and operatively coupled to the plunger 204. Particularly, the actuator 206 may be coupled to the bottom portion 226 of the plunger 204. For example, the actuator 206 may be actuated to move the plunger 204 through the at least one container 202 and the cross-section 216 for dispersing the flavoring agent to the cross-section 216. Thus, the flavoring agent may be configured to be mixed with the water flowing through the cross-section 216 for making the beverage. The flowing of the water through the cross-section 216 to make the beverage is explained in greater detail, hereinafter.

As explained in FIG. 1, the outlet pipe 214 (FIG. 2) may be coupled to the receptacle 108 of the water storage 102 via the first intake. Moreover, again referring to FIG. 2, the outlet pipe 214 may include a water plunger 230 coupled to the actuator 206, and configured to regulate the flow of the water from the receptacle 108 within the outlet pipe 214. Further, the water plunger 230 may include an inlet 232. For example, the water plunger 230 may be moved in a vertically downward direction, in response to the actuation of the actuator 206, to align the inlet 232 with the cross-section 216 of the outlet pipe 214. The actuation of the actuator 206 is explained in greater detail hereinafter.

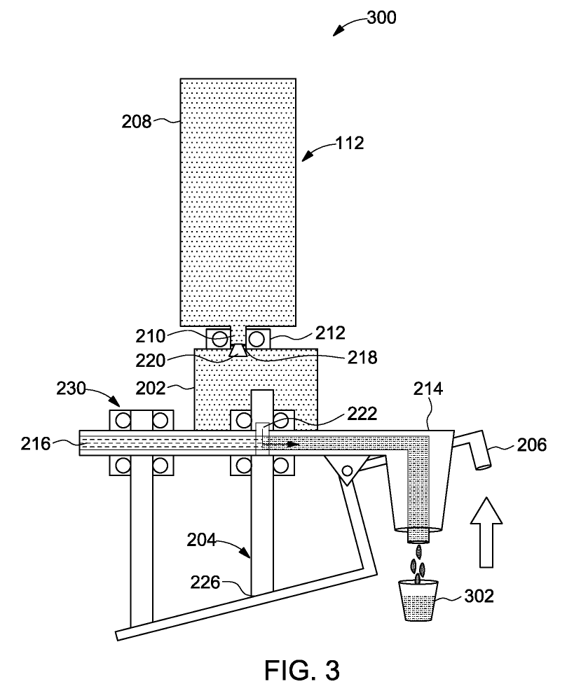

In an embodiment, referring to FIG. 3 , which illustrates a first-sectional view 300 of the beverage making assembly 104 in an actuated state, in accordance with an embodiment of the present disclosure. In an embodiment, the actuator 206 may be any one of manually actuated or electronically actuated by an actuator. By way of example, the actuator 206 may include a lever pivoted to the outlet pipe 214 and operatively coupled to the plunger 204 and the water plunger 230.

As apparent from FIG. 3, the actuator 206 may be manually actuated by a user. In response to the actuation of the actuator 206, the water plunger 230 may be moved in the vertically downward direction to align the inlet 232 with the cross-section 216 of the outlet pipe 214. Such alignment may allow the passage of the water within the cross-section 216 through the inlet 232 (refer to FIG. 2). Additionally, the plunger 204 may be moved in the vertically downward direction to align the top notch 222 with the cross-section 216. Such alignment enables mixing of the flavoring agent with the water flowing in the cross-section 216, thereby making the beverage. The beverage made may be poured into a beverage receptacle 302 for consumption. By way of example, the beverage receptacle may be a acrylic glass, cup, tumbler, and the like.

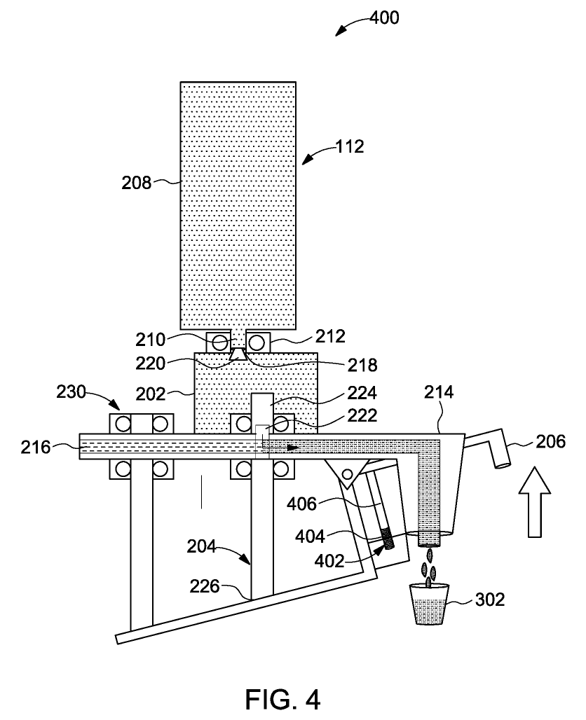

In an embodiment, referring to FIG. 4 , which illustrates a second-sectional view 400 of the beverage making assembly 104 in the actuated state, in accordance with an embodiment of the present disclosure. As apparent from FIG. 4, the actuator 206 may be actuated by the actuator 402. In an exemplary embodiment, the actuator 206 may be a solenoid-based actuator. For example, the solenoid-based actuator 402 may be IOT (Internet of Things)-based solenoid actuator 402, and may be communicably coupled to, and operated by a user-device. For example, the solenoid-based actuator 402 may include a coil 404 such as a solenoid, and a moveable core 406 such as a metal plunger engaged to the coil 404. Upon receipt of an input command from the user-device, the movable core 406 may strike the actuator 206. Such striking may enable actuation of the lever in the vertically downward direction. Due to such actuation, the inlet 232 of the water plunger 230 and the top notch 222 of the plunger 204 may be aligned with the cross-section 216. Thus, the flavoring agent may be mixed with the water flowing in the cross-section 216, thereby making the beverage. Further, the beverage made may be poured into the beverage receptacle 302 for consumption.

In an embodiment, referring to FIG. 5 , which illustrates a sectional view 500 of the beverage making assembly 104 with the dual-container configuration, in accordance with an embodiment of the present disclosure. In an embodiment, the dual-container configuration may include a first collecting container 502 coupled to the valve 212 and a second collecting container 504 disposed above the outlet pipe 206 fluidically coupled to the first collecting container 502. For example, the first collecting container 502 may include the first cavity 218 coupled to the valve 212. Due to such coupling, the first collecting container 502 may be configured to receive the flavoring agent from the flavor storage 112 via the valve 212. By way of another example, the first cavity 218 may be coupled to the needle 220 such that the opening 210 of the flavor storage 112 may be pierced to allow the flow of the flavoring agent flow towards the first collecting container 502. Further, the second collecting container 504 may be disposed beneath the first collecting container 502, and configured to receive the flavoring agent from the first collecting container 502 in a predefined amount via the one or more notches 222 of the plunger 204.

Therefore, a junction cavity 505 may be formed between the first collecting container 502 and the second collecting container 504. The junction cavity 505 may define a passage to allow movement of the plunger 204 through the first collecting container 502, the cross-section 216, and the second collecting container 504. As a result, the flavoring agent may flow, in the predefined amount, from the first collecting container 502 to the second collecting container 504. Further, such flow may be enabled via the top notch 222 of the plunger 204.

Further, the second collecting container 504 may include a second cavity 507 configured to allow the flow of the flavoring agent from the second collecting container 504 into the cross-section 216 of the outlet pipe 206. It is to be noted, the flavoring agent may flow from the second collecting container 504 to the cross-section 216 based on the movement of the plunger 204 through the first collecting container 502, and the second collecting container 504. The operation and the assembly of the plunger 204 is explained in greater details, hereinafter.

With continued reference to FIG. 5, and as already explained in FIG. 2, the plunger 204 may include the top portion 224 and the bottom portion 226. The top portion 224 may include the top notch 222 which may be engaged to the junction cavity 505 such that, the flavoring agent may flow from the first collecting container 502 to the second collecting container 504. Further, the bottom portion 226 may include a bottom notch 506. The bottom notch 506, in response to the actuator 206, may be configured to receive the flavoring agent from the second collecting container 504 and dispense the flavoring agent within the cross-section 216 of the outlet pipe 214. The movement of the plunger 204 in response to the actuation of the actuator 206 is explained in conjunction with FIG. 6.

In an embodiment, Referring to FIG. 6 , which illustrates a sectional view 600 of the beverage making assembly 104 of FIG. 5, in accordance with an embodiment of the present disclosure. FIG. 6 is explained in conjunction with FIG. 5. As explained in FIG. 3 and FIG. 4, the actuator 206 may be any one of manually actuated or actuated by the actuator 402, respectively.

As apparent from FIG. 6, the actuator 206 may include the lever pivoted to the outlet pipe 214 and operatively coupled to the plunger 204. When the lever may be actuated manually, the plunger 204 may be actuated to move through the first collecting container 502 from the junction cavity 505 i.e., in the upward direction. Due to such movement, the top notch 222 may be disengaged from the junction cavity 505 and the bottom notch 506 may be aligned to the cross-section 216 and the second cavity 507. As will be appreciated, the bottom notch 506 may provide passage for the flow of the flavoring agent from the second collecting container 504 to the cross-section 216. As a result, the flavoring agent may be mixed with the water flowing through the cross-section 216, thereby making the beverage. Further, the beverage made may be poured into the beverage receptacle 302. The flowing of the water through the cross-section 216 is already explained in FIG. 2.

In another exemplary embodiment, the actuator 206 may be actuated by the solenoid-based actuator 402. The solenoid-based actuator 402 may be IOT (Internet of Things)-based solenoid actuator 402, and may be communicably coupled to, and operated by a user-device. The operation of the solenoid-based actuator 402 is already explained in FIG. 4. Further, the actuation of the actuator 206 may result in aligning the bottom notch 506 with the cross-section 216 and the second cavity 507 to allow mixing of the flavoring agent within the water flowing through the cross-section 216 to make the beverage. Further, the beverage made may be poured into the beverage receptacle 302. The making of the beverage is already explained in greater detail in conjunction with FIG. 1-5.

As will be appreciated by those skilled in the art, the beverage making assembly described in the various embodiments discussed above are not routine, or conventional or well understood in the art. The beverage making assembly discussed above may be capable of offering several advantages. The beverage making assembly may be retrofitted in the water storages, such as water pots, water filters. Therefore, the beverage making assembly may be utilized in households, cafes, public spaces and the beverages of desired flavor may be obtained without requirement of skilled operator.

Further, the beverage making assembly may be capable of making beverage by mixing the flavor liquid in the water flowing through the cross-section of the outlet pipe in the predefined amount. Additionally, the flow of the fluid liquid may be regulated from the valve. Therefore, the beverage making assembly simplifies water flavoring, enhances user convenience, and encourages healthier hydration habits. Thus, the disclosed assembly try to overcome the technical problem of making the beverage.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A beverage making assembly comprising:
a flavor storage configured to store a flavoring agent, wherein the flavor storage comprises:
an enclosure;
an opening coupled to the enclosure; and
a valve disposed within the opening;
at least one container fluidically coupled to the valve, wherein each container is configured to receive the flavoring agent from the flavor storage via the valve;
a plunger disposed within the at least one container and disposed in a cross-section of an outlet pipe of a water storage, wherein the plunger comprises:
one or more notches, wherein each notch allows a flow of the flavoring agent across at least one container, and from at least one container to the cross-section of the outlet pipe;
an actuator pivoted on the outlet pipe and operatively coupled to the plunger, wherein the actuator is actuated to move the plunger through the at least one container and the cross-section for dispersing the flavoring agent to the cross-section, wherein the flavoring agent is configured to be mixed with a water flowing through the cross-section for making a beverage.

2. The beverage making assembly of claim 1, wherein when the at least one container comprises any one of:
a single-container configuration; or
a dual-container configuration comprising;
a first collecting container configured to receive the flavoring agent from the flavor storage via the valve; and
a second collecting container is disposed on the outlet pipe fluidically connected to the first collecting container, wherein the second collecting container is configured to receive the flavoring agent from the first collecting container in a predefined amount via the one or more notches of the plunger.

3. The beverage making assembly of claim 2, wherein the plunger comprises:
a top portion disposed within the at least one container, wherein the top portion comprises:
a top notch;
a bottom portion disposed opposite to the top portion, and coupled to the actuator, wherein in the dual-container configuration, the bottom portion comprises:
a bottom notch, wherein the bottom notch is configured to:
receive the flavoring agent from the second collecting container; and
dispense the flavoring agent within the cross-section of the outlet pipe.

4. The beverage making assembly of claim 3, wherein in the single-container configuration:
the top notch is configured to:
receive the flavoring agent from the at least one container; and
dispense the flavoring agent to the cross-section of the outlet pipe in response to the actuation of the actuator.

5. The beverage making assembly of claim 4, wherein the outlet pipe comprises:
a water plunger coupled to the actuator, and configured to regulate a flow of the water from a water storage within the outlet pipe, wherein the water plunger comprises:
an inlet,
wherein the water plunger is moved in a vertically downward direction, in response to the actuation of the actuator, to align the inlet with the cross-section of the outlet pipe.

6. The beverage making assembly of claim 1, wherein the actuator is any one of:
manually actuated, or
actuated with an actuator.

7. A water storage, comprising:
an outlet pipe;
a beverage making assembly coupled to the outlet pipe, wherein the beverage making assembly comprises:
a flavor storage configured to store a flavoring agent, wherein the flavor storage comprises:
an enclosure;
an opening coupled to the enclosure; and
a valve disposed within the opening;
at least one container fluidically coupled to the valve, wherein each container is configured to receive the flavoring agent from the flavor storage via the valve;
a plunger disposed within the at least one container and disposed in a cross-section of the outlet pipe of the water storage, wherein the plunger comprises:
one or more notches, wherein each notch allows a flow of the flavoring agent across at least one container, and from at least one container to the cross-section of the outlet pipe; and
an actuator pivoted on the outlet pipe and operatively coupled to the plunger, wherein the actuator is actuated to move the plunger through the at least one container and the cross-section for dispersing the flavoring agent to the cross-section, wherein the flavoring agent is configured to be mixed with a water flowing through the cross-section for making a beverage.

8. The water storage of claim 7, wherein when the at least one container comprises any one of:
a single-container configuration; or
a dual-container configuration comprising;
a first collecting container configured to receive the flavoring agent from the flavor storage via the valve; and
a second collecting container is disposed above the outlet pipe fluidically coupled to the first collecting container, wherein the second collecting container is configured to receive the flavoring agent from the first collecting container in a predefined amount via the one or more notches of the plunger.

9. The water storage of claim 8, wherein the plunger comprises:
a top portion disposed within the at least one container, wherein the top portion comprises:
a top notch;
a bottom portion disposed opposite to the top portion, and pivoted to the actuator, wherein in the dual-container configuration the bottom portion comprises:
a bottom notch, wherein the bottom notch is configured to:
receive the flavoring agent from the second collecting container; and
dispense the flavoring agent within the cross-section of the outlet pipe.

10. The water storage of claim 9, wherein in the single-container configuration:
the top notch is configured to:
receive the flavoring agent from the at least one container; and
dispense the flavoring agent to the cross-section of the outlet pipe in response to the actuation of the actuator.

11. The water storage of claim 7, wherein the outlet pipe comprises:
a water plunger coupled to the actuator, and configured to regulate a flow of water from the water storage within the outlet pipe, wherein the water plunger comprises:
an inlet,
wherein the water plunger is moved in a vertically downward direction, in response to the actuation of the actuator, to align the inlet with the cross-section of the outlet pipe.

12. The water storage of claim 7, wherein the actuator is any one of:
manually actuated, or
actuated with an actuator.
